(19) United States
(12) Patent Application Publication
(10) Pub. No.: US 2014/0117165 A1
(43) Pub. Date: May 1, 2014

(54) MOTORIZATION SYSTEM FOR HINGE WITH FLEXIBLE ROLLING TRACKS

(71) Applicant: THALES, Neuilly-sur-Seine (FR)

(72) Inventors: Yannick BAUDASSE, Cannes La Bocca (FR); Stephane VEZAIN, Cannes La Bocca (FR); Didier STANEK, Cannes La Bocca (FR)

(21) Appl. No.: 14/062,715

(22) Filed: Oct. 24, 2013

(30) Foreign Application Priority Data
Oct. 26, 2012 (FR) 12 02861

(51) Int. Cl. B64G 1/22

(52) U.S. Cl. CPC B64G 1/222
USPC 244/172.6; 16/366

(57) ABSTRACT

A motorization device comprises two substantially parallel winding cylinders, at least longitudinal link element-forming winding means, the winding means being suitable for maintaining a predetermined distance between the winding cylinders and being wound around the winding cylinders, and at least two flexible tracks, a flexible track being fixed to each winding cylinder, the flexible tracks being arranged facing one another and having a point of contact, a prestressing force being applied at said point of contact of the flexible tracks under the effect of the winding means. The motorization device comprises elastic means arranged between each winding cylinder and the corresponding flexible track, the elastic means being configured so as to exert a radial compression force on each flexible track, normal to the surface of the flexible track at least at said point of contact.

### CROSS-REFERENCE TO RELATED APPLICATION

This application claims priority to foreign French patent application No. FR 1202861, filed on Oct. 26, 2012, the disclosure of which is incorporated by reference in its entirety.

### FIELD OF THE INVENTION

The present invention relates to the motorization systems of elements. It applies notably to the field of the deployment mechanisms for space appendages, such as antennas or solar generators for example.

### BACKGROUND

In the abovementioned motorization systems, elements, for example fittings, are typically set in motion relative to one another around hinges. These systems thus comprise hinge lines that generally use motorization components of the torsion spring, spiral spring or Carpentier joint type, making it possible to counter the resisting torques and guarantee the necessary margins in terms of torques generated in order to ensure the complete deployment of the appendages.

In this context, the known motorization components exhibit a changing or variable motorization torque that implies an over-motorization which causes shocks at the end of deployment.

The shocks can be significant and generate damage to the space appendages at the end of deployment, as well as damaging stray torques that are damaging to the piloting of the spacecraft. To mitigate this problem, the deployable structures can be dimensioned and reinforced in such a way as to be able to withstand the end-of-travel shocks generated at the time of their deployment, but this solution is unsatisfactory and notably results in an increased weight for the complete structure.

Some developments have lead to the devising of deployment mechanisms with almost zero resistive torque. Such mechanisms, such as the hinge line described in patent application FR 2635077, offer the advantage of requiring only little motorization power and generate minimized end-of-travel shocks. Other mechanisms born out of enhancements made to the above mechanism, in terms of weight and volume notably. Such a deployment mechanism is disclosed in patent application FR 0605653.

The known mechanisms, such as those described in patent applications FR 2635077 and FR 0605653 mentioned above, have an angular deployment capability that is limited to 180°. Moreover, their overall kinematics, because of their structure, generates very irregular motorization torques. Finally, the speed of deployment of the known deployment mechanisms, as already stated, results in restoration of energy at end of travel, therefore a shock, because said speed of deployment is not regulated.

To correct these drawbacks, a motorization device has been proposed with controlled torque, described in the patent application published under the reference FR 2968234. Such a device makes it possible to have an almost zero resisting toque, and is based on the use of flexible rolling tracks that already exist in the system, to produce the motorization. A specific form is given to the flexible tracks so as to allow for an offset of the point of contact between the flexible tracks relative to the point of crossover of winding means such as wound flexible blades or even cables, forming a link element between two fitting-forming substantially parallel winding cylinders, to which different components of the system are linked. In this way, a torque dependent on the distance between the abovementioned point of contact and point of crossover provokes the rotation of the fittings between them. The expression “point of crossover” between the link element-forming winding means should be understood in the wider sense to be the axis substantially parallel to the longitudinal axes or axes of revolution of the fittings, passing through both of the two winding means. An example of motorization device with controlled torque as described above is described in more detail hereinbelow with reference to FIG. 1.

In the abovementioned device, given that a specific form is given to the flexible tracks, this specific form being like the form of an Archimedes spring or spiral spring, a problem arises linked to the lateral deflection of the tracks under the stress. The lateral deflection of the tracks induces a problem of control of the motorization torque of the device. This problem is illustrated by FIG. 2, described hereinbelow.

### SUMMARY OF THE INVENTION

One aim of the present invention is notably to mitigate the abovementioned drawbacks. Thus, there is proposed, through the present invention, a motorization device comprising at least two flexible rolling tracks, the latter being associated with elastic means allowing for a radial compression of the flexible tracks, in order to ensure that a force normal to the surface of each flexible track is exerted at the point of contact between the flexible tracks.

Another advantage of the present invention is that a motorization device according to one of the embodiments described offers a substantial volume saving relative to the devices known from the prior art, as well as a substantial saving in terms of weight.

Another advantage of the present invention is that a motorization device according to one of the embodiments described also offers a substantial saving in terms of solidity and robustness.

More specifically, the subject of the invention is a motorization device comprising two substantially parallel winding cylinders, at least longitudinal link element-forming winding means, the winding means being suitable for maintaining a predetermined distance between the winding cylinders and being wound around the winding cylinders, and at least two flexible tracks, a flexible track being fixed to each winding cylinder, the flexible tracks being arranged facing one another and having a point of contact, a prestressing force being applied at said point of contact of the flexible tracks under the effect of the winding means, the motorization device also comprising elastic means arranged between each winding cylinder and the corresponding flexible track, the elastic means being configured so as to exert a radial compression force on each flexible track, normal to the surface of the flexible track at least at said point of contact.

In one embodiment of the invention, the flexible tracks can be cylindrical with spiral section.

In one embodiment of the invention, the flexible tracks can be cylindrical with circular section.

In one embodiment of the invention, the elastic means can be formed by a mesh comprising a plurality of cells or a three-dimensional array of beams or plates.

In one embodiment of the invention, the elastic means associated with a flexible track can be formed by a plurality of cells arranged in the volume contained between the outer circumference of the winding cylinder and the inner circumference of the flexible track.

In one embodiment of the invention, the cells can have a length less than or equal to the width of the roll band of the flexible tracks.

In one embodiment of the invention, the cells can have a polygonal section.

In one embodiment of the invention, the cells can be configured in such a way that the elastic means constitute an auxetic structure.

In one embodiment of the invention, the elastic means can be arranged around all of the outer circumference of the winding cylinders.

In one embodiment of the invention, the elastic means can be arranged around a determined angular portion of the outer circumference of the winding cylinders.

Another subject of the present invention is a deploying system for satellite, comprising at least one first deployable appendage, one second deployable appendage, and a motorization device according to any one of the embodiments described, the deployable appendages being fixed to each assembly formed by a winding cylinder and a flexible track.

### BRIEF DESCRIPTION OF THE DRAWINGS

Other features and advantages of the invention will become apparent from the following description given in light of the appended drawings which represent:

FIG. 1, a diagram of a rolling hinge system with motorization torque, known from the prior art, in the stowed and deployed positions;

FIG. 2, a diagram synoptically illustrating a phenomenon of deflection of the flexible tracks;

FIG. 3, a perspective view illustrating a part of a motorization device according to an exemplary embodiment of the invention.

### DETAILED DESCRIPTION

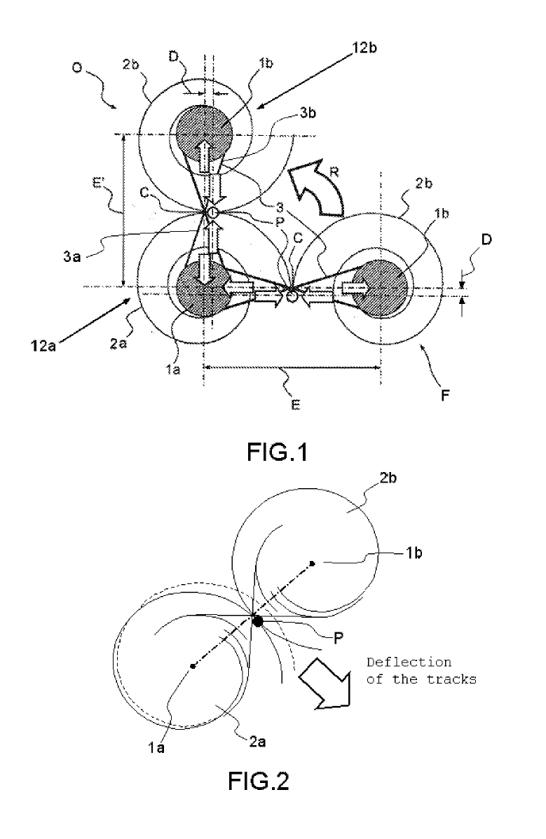

FIG. 1 shows a diagram illustrating a motorization system as described in the abovementioned patent application FR 2968234. A motorization system comprises winding cylinders 1a, 1b that are substantially parallel and held in position by winding means 3 such as flexible blades, or by any other suitable element, such as, for example, cables. The winding means 3 are wound in a figure of eight around winding cylinders 1a, 1b; taken separately, each winding means notably comprises a linear portion 3a or 3b, each linear portion 3a, 3b being extended by a portion of the winding means wound around each of the winding cylinders 1a, 1b. The winding means cross over at a crossover point C.

Flexible tracks 2a, 2b are respectively connected to each of the winding cylinders 1a, 1b with circular section. The flexible tracks 2a, 2b are arranged facing one another and in contact with one another. An assembly comprising a winding cylinder 1a, 1b and an associated flexible track 2a, 2b form a fitting 12a, 12b. The winding means 3 induce a prestressing force that is applied at the point of contact P between the flexible tracks 2a, 2b. Because of the basically circular geometry of the winding cylinders 1a, 1b and of the flexible tracks, the point of contact P between the flexible tracks 2a, 2b and the crossover point C of the winding means 3 are aligned on a plane orthogonal to the plane passing through the two axes of revolution of the two winding cylinders 1a, 1b, and parallel and equidistant from the axes of revolution of the two winding cylinders 1a, 1b. Appendages, such as solar generators, can be fixed to each winding cylinder/flexible track assembly 1a-2a/1b-2b.

The flexible tracks 2a, 2b may consist of flexible tracks in spiral form. The profile of the flexible tracks 2a, 2b can also be formed by a plurality of spiral portions, and/or by a plurality of portions of circular profile. The specific spiral form makes it possible to offset the point of contact P between flexible tracks 2a, 2b relative to the crossover point C of the winding means 3. The point of contact P and the crossover point C are not on the same axis parallel to the axes of revolution of the winding cylinders 1a, 1b. This offset by a distance D, of the point of contact P relative to the crossover point C, results in the offsetting of the prestressing force induced by the winding means 3 that is applied at the point of contact P. Because of this, a torque R is produced between the point of contact P and the crossover point C inducing the rotation of the fittings 12a, 12b, comprising the flexible tracks 2a, 2b and the winding cylinders 1a, 1b. The mutual rotation of the fittings 12a, 12b, because of their spiral form, results in a variation of the deformation of the flexible tracks 2a, 2b and, more specifically, of the deflection at the point of contact, the centre-to-centre distance between the winding cylinders 1a, 1b, for its part, being constant, the length E of the centre-to-centre distance in the closed position F being equal to the length E′ in the open position O, because of the cylindrical form with circular section of the winding cylinders 1a, 1b.

The torque R can be adjusted by means of the choices made concerning the form of the spiral and concerning the physical characteristics of the flexible tracks 2a, 2b, in particular their elasticity and their rigidity. To increase the torque R exerted on the flexible tracks 2a, 2b, it is possible to increase the offset of the point of contact P relative to the crossover point C by producing a spiral with a large aperture angle, or to increase the force exerted at the point of contact P by producing a stiffer flexible track. To increase the force exerted at the point of contact C, it is also possible to increase the deflection of the flexible tracks 2a, 2b.

To generate a torque R that is constant during the deployment phase, an Archimedean spiral form may be preferred.

The motorization torque R can also be adapted in order to compensate certain variable friction torques introduced by elements external to the hinge. These may typically be bundles of electrical cables carrying the electricity between two solar generator panels. It is thus possible to obtain a motorization margin that is almost constant throughout the deployment. The motorization demand can then be adjusted as strictly necessary.

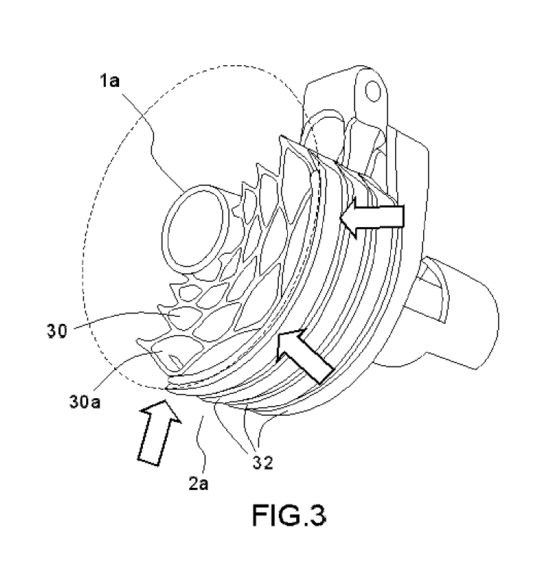

FIG. 2 synoptically illustrates a phenomenon of deflection of the flexible tracks, occurring with a motorization system as described previously with reference to FIG. 1.

FIG. 2 represents a partial section of a motorization device notably comprising two flexible tracks 2a, 2b arranged around winding cylinders 1a, 1b. During a movement of the winding cylinders 1a, 1b, for example during a right rotation movement of the first winding cylinder 1a, associated with a left rotation movement of the second winding cylinder 1b as in the nonlimiting example illustrated by the figure, a lateral deflection of the flexible tracks 2a, 2b occurs, resulting in an undesirable displacement of the point of contact P in a direction tangential to the flexible tracks 2a, 2b. As indicated previously, the displacement of the point of contact P impairs good control of the motorization torque of the motorization device.

Through the present invention, it is proposed that tracks of overall cylindrical form, for example with section of spiral form, are associated with elastic means allowing for a radial compression of the flexible tracks, so as to ensure that a force normal to the surface of each flexible track is exerted at the point of contact between the flexible tracks. The section of the flexible tracks may also be, for example, of circular form. FIG. 3 described hereinbelow presents a nonlimiting exemplary embodiment of a flexible track associated with elastic means.

FIG. 3 presents a perspective view illustrating a part of a motorization device according to an exemplary embodiment of the invention.

FIG. 3 notably illustrates a winding cylinder 1a around which is arranged a flexible track 2a.

In the example illustrated by FIG. 3, the flexible track 2a of a motorization device not represented in full, is overall of spiral form, and arranged around a winding cylinder 1a. The flexible track 2a may, for example, consist of a plurality of mutually parallel roll bands 32.

The motorization device also comprises elastic means 30 arranged between the winding cylinder 1a and the flexible track 2a. The elastic means are configured in such a way as to produce a spring effect, and to keep the flexible tracks firmly in contact, by exerting a radial compression force on each flexible track, normal to the surface of the flexible track at least at the point of contact between the flexible tracks.

The elastic means can be produced by flexible structures, such as meshes formed of cells or three-dimensional arrays of beams or plates.

In the example illustrated by FIG. 3, the elastic means may be formed by a plurality of cells 30a forming a flexible mesh. The cells 30a may be overall cylindrical on a plurality of axes parallel to the axis of revolution of the winding cylinder 1a. In the example illustrated by the figure, the cells 30a extend overall over a length less than or equal to the width of the total roll band provided by the flexible track 2a, it being understood that this is not a limiting example of the present invention. The cells 30a can have sections of various forms. In the example illustrated by FIG. 3, the cells 30a have sections in the form of irregular hexagons, the areas of which increase with distance from the winding cylinder 1a to the flexible track 2a. Other forms can be envisaged, notably other polygons, scaly forms, etc.

Advantageously, the sections of the cells 30 can have forms such that the elastic beams have an auxetic structure, that is to say with negative Poisson's ratio. The cells can, for example, have sections in diabolo form.

An auxetic structure offers the advantage of being able to be deformed under the effect of a radial displacement of the flexible track subject to very little in the way of tangential stress, compared to a conventional structure. This advantage therefore makes it possible to minimize the tangential deflection of the point of contact of the flexible tracks.

Another advantage of an auxetic structure is linked to the fact that the latter can be used to dissipate energy and thus regulate the speed of rotation of the fittings. In practice, cells with an auxetic structure can, for example, be filled with a damping material, for example a material of visco-elastic type. If we consider the cell volume, the latter will vary in strong proportions during a deformation by comparison with a conventional structure, the damping material will therefore undergo significant pressure differences and will therefore dissipate more energy which will generate rotation speed regulation.

The elastic means may be arranged around the entire outer circumference of the winding cylinder 1a, in the space contained between the winding cylinder 1a and the inner circumference of the flexible track 2a. In an advantageous embodiment, as illustrated by FIG. 3, the cells 30a may be arranged around only an angular portion of the circumference of the winding cylinder 1a, such a configuration offering an additional advantage in terms of saving in weight and volume.

1. A motorization device comprising:
two substantially parallel winding cylinders, at least one longitudinal link element-forming winding means, the winding means being suitable for maintaining a predetermined distance between the winding cylinders and being wound around the winding cylinders, and at least two flexible tracks, a flexible track being fixed to each winding cylinder, the flexible tracks being arranged facing one another and having a point of contact, a prestressing force being applied at said point of contact of the flexible tracks under the effect of the winding means, wherein the motorization device comprises elastic means arranged between each winding cylinder and the corresponding flexible track, the elastic means being configured so as to exert a radial compression force on each flexible track, normal to the surface of the flexible track, at least at said point of contact.

2. The motorization device of claim 1, wherein the flexible tracks are cylindrical with spiral section.

3. The motorization device of claim 1, wherein the flexible tracks are cylindrical with circular section.

4. The motorization device according to claim 1, wherein the elastic means are formed by a mesh comprising a plurality of cells or a three-dimensional array of beams or plates.

5. The motorization device according to claim 1, wherein the elastic means associated with a flexible track are formed by a plurality of cells arranged in the volume contained between the outer circumference of the winding cylinder and the inner circumference of the flexible track.

6. The motorization device of claim 5, wherein the cells have a length less than or equal to the width of the roll band of the flexible tracks.

7. The motorization device of claim 5, wherein the cells have a polygonal section.

8. The motorization device of claim 5, wherein the cells are configured in such a way that the elastic means constitute an auxetic structure.

9. The motorization device of claim 1, wherein the elastic means are arranged around all of the outer circumference of the winding cylinders.

10. The motorization device of claim 1, wherein the elastic means are arranged around a determined angular portion of the outer circumference of the winding cylinders.

11. A deploying system for satellite, comprising at least one first deployable appendage, one second deployable appendage, and a motorization device according to claim 1, the first and the second deployable appendages being fixed to each assembly formed by a winding cylinder and a flexible track.
